(19) United States
(12) Patent Application Publication
(10) Pub. No.: US 2005/0182639 A1
(43) Pub. Date: Aug. 18, 2005

(54) Dynamic virtual organization manager

(75) Inventor: Jonathan Dale, San Francisco, CA (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 10/782,472

(22) Filed: Feb. 18, 2004

(51) Int. Cl. G06F 17/60

(52) U.S. Cl. 705/1

(57) ABSTRACT

A system includes a number of services and agents interconnected by a communication network. An organization agent determines business function descriptions detailing various business requirements. The organization agent contacts and interacts with services to determine potential services for fulfilling business requirements.

### TECHNICAL FIELD OF THE INVENTION

The present invention relates generally to organization management and, more particularly, to dynamic virtual organization management using intelligent agents.

### BACKGROUND OF THE INVENTION

The introductions of the internet and worldwide web have unleashed a flood of information. Users and businesses can now obtain unparalleled access to information and features. Moreover, the proliferation of the internet and other communication networks permit rapid and effective communications between any number of organizations. However, existing technology for organizations has yet to fully exploit the current and anticipated advances.

### SUMMARY OF THE INVENTION

In accordance with the present invention, techniques for dynamic virtual organization management using agents are provided. According to particular embodiments, these techniques enable agents to automatically perform business organization tasks and planning. For example, an organization agent may perform tasks to automatically discover and exploit cost saving services which are intrinsically part of its business logic.

According to a particular embodiment, a method for automated management of business services establishes an organizational database maintaining at least one business function description that includes a business function indicator and business function requirements. The method accesses a service registry using the business function indicator to identify a network address for each of multiple service providers each having a service indicator matching the business function indicator. For each of the identified service providers, the method communicates with the service provider to determine feature interfaces for interacting with the service provider, accesses at least one of the feature interfaces of the service provider to determine service descriptors describing a service provided by the service provider, and determines whether the service provider is satisfactory based on if the service descriptors satisfy at least a portion of the business function requirements. The method also ranks each of the satisfactory service providers based on the service descriptors from each of the satisfactory service providers.

Embodiments of the invention provide various technical advantages. A system operating according to these techniques may enable automation of certain business operations and activities. For example, organizational agents may automate searches for particular services and negotiation with these services. This may enable automated searching for more cost effective services or otherwise more desirable service providers. Particular embodiments may provide for dynamic composition of services to fulfill tasks. This may enable, for example, automated and dynamic aggregation of services to help achieve business goals. Moreover, various embodiments may permit an organizational agent to advertise business needs and receive contacts from potential services to fulfill those needs.

Because of the relatively open nature of interactions between elements, the system may permit any number of entities to design and offer services. Thus, the system may be scalable and extensible. Particular embodiments may operate in accordance with publicly developed communication standards. Also, a wide variety of services and service providers increases flexibility and further enhances the dynamic nature of the system.

The system may support any number of agents acting on behalf of users, service providers, and/or intermediaries to facilitate dynamic service composition. These agents communicate while operating in the interests of their owners to facilitate the access to and interaction with services. Each agent can operate according to its particular information to accomplish the goals of its owner. For example, an organizational agent may operate according to a plan while applying business goals to discover and negotiate with services that match to the organization's preferences.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a system that includes service providers and organizations that operate according to particular embodiments of the present invention;

FIG. 2 is a block diagram illustrating components of an agent from the system that can help enable dynamic organization management;

FIG. 3 is a block diagram illustrating functional elements of a service from the system; and

FIG. 4 is a flowchart illustrating a method for providing automated organization management of services for an organization.

### DETAILED DESCRIPTION OF THE DRAWINGS

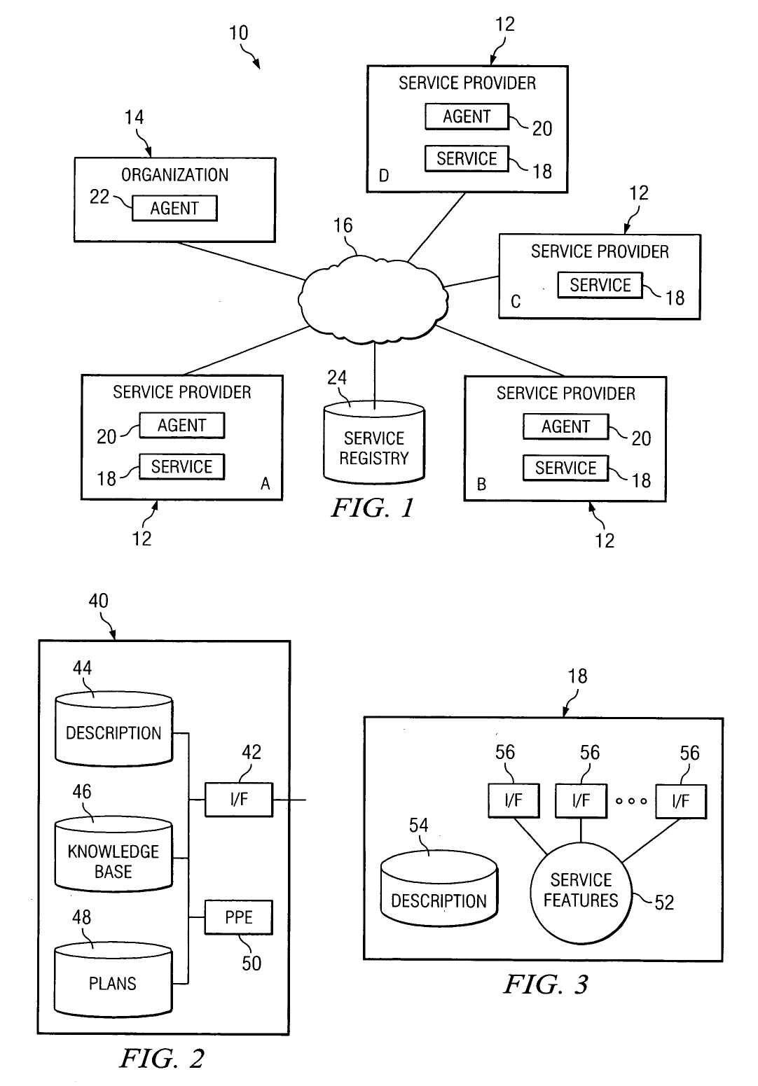

FIG. 1 illustrates a system, indicated generally at 10, that includes multiple service providers 12 and an organization 14 interconnected by a communication network 16. Each service provider 12 offers a service 18, potentially using a service agent 20 to facilitate offering of the service 18 to organizations. Organization 14 includes an organization agent 22 that facilitates the interaction with one or more services 18 to fulfill specific business functions or requirements. According to particular embodiments, organization agent 22 interacts with other elements of system 10 to identify services 18 that will fulfill business functions according to preferences of organization 14. For example, organization agent 22 may interact with multiple service providers 12 to identify and negotiate for receiving services 18 providing goods or services, such as supplies or outsourced business functions.

Each service provider 12 represents any suitable collection of components capable of offering access to services through defined interfaces. Service providers 12 offer machine readable interfaces that enable structured queries to access and interact with information regarding services 18. For example, a particular service provider 12 may provide access to and interaction with a materials supply system. To provide these functions, service 18 may support any number of features and provide interfaces to these features. For example, for a materials supply system, service 18 may offer interfaces to features such as pricing and ordering. Each feature within a service 18 may provide any suitable level of sophistication. For example, a pricing feature may support sophisticated negotiation using a large number of pricing criteria, while the ordering feature may simply require input of specified fields.

To provide access to features, service 18 makes a description available. This description may provide information of varying specificity. This may include generic information describing the nature of service 18, what interface languages service 18 supports, and generically what service 18 can achieve. This may further include specific information, such as precise features offered by service 18 and techniques for interfacing with those features. Using the materials supply system example, service 18 may include a description with generic information identifying service 18 as a materials supply system and specifying a language, such as standard materials negotiation and ordering language, supported by service 18. Service 18 may further include specific descriptors identifying particular features and techniques for interfacing with those particular features. According to particular embodiments, service 18 may advertise and operate according to publicly developed and available standards for communications.

To provide extended functionality, service providers 12 may include service agents 20. Service agents 20 can extend functionality offered by service providers 12 by enabling operations such as composition of other services and “pushing” of services to organizations 14. Thus, just as an individual organization 14, using organization agent 22, may seek out, interact with, and compose a number of services 18, service agent 20 can similarly seek out, interact with, and compose any number of remote services 18. For example, consider service provider 12 offering a travel agent-type service. This travel service agent 20 may seek out other service providers 12, such as ground transportation services, airlines, hotels, and entertainment services and compose these services 18 into a combined service offering. Organization agent 22 may then access the travel service agent 20 to schedule some or all travel arrangements for personnel. This enables a distribution of functionality and a hierarchical process whereby tasks and subtasks can find and link to services 18 at multiple levels to provide specific functions.

Service agents 20 may also provide for pushing of services 18 to other service providers 12 and/or organizations 14. For example, service agent 20, using communication network 16, may identify other entities that have expressed an interest in a particular type of service 18. Service agent 20 may then contact these entities and advertise the availability and features supported by service 18. As an example, consider organization 14 publishing a need for particular materials. Service agents 20 may discover these needs and then contact organization 14 to attempt to advertise or negotiate for providing the needed materials.

System 10 may include any number and type of service providers 12 offering various services 18. For example, system 10 may include services 18 for supplying goods or offering functions such as payroll management, travel services, human resource tasks, facilities management and maintenance, and other appropriate business services. These various services 18 may be standards based, corporation driven, dynamically created or otherwise specified to support appropriate interactions between organizations 14 and services 18. Moreover, it should be recognized that an increase in the number of services 18 and/or the number of individual services 18 providing each type of service can increase the effectiveness of system 10. Thus system 10 contemplates any suitable number and type of service providers 12 offering various services 18.

Organization 14 represents any suitable combination and arrangement of components that enable interaction with users and other elements of system 10. Organization 14 supports discovery and interaction with services 18 to investigate and fulfill organization specified tasks. For example, organization 14 may identify a particular service 18 for handling payroll functions and then interact with the particular service 18 to negotiate or otherwise determine particular terms. Organization 14 may then link to and use the identified service 18. For example, for payroll services, organization 14 may supply selected employment records and financial information to enable service 18 to fulfill payroll functions. Within organization 14, organization agent 22 handles this dynamic discovery and interaction by interfacing with service providers 12 and other elements of system 10. To perform organization management, organization agent 22 and/or organization 14 maintain a variety of information, such as plans, rule systems, and organization descriptors.

During operation, organization agent 22 uses information from plans to identify business requirements and services 18 for potentially fulfilling those requirements. According to particular embodiments, the plans include a number of business function descriptions each defining general and specific requirements for obtaining particular services. For example, for a supply service, the business function description may generally define the types of materials required, supply chain management information indicating the anticipated needs, and details regarding current suppliers. For a payroll service, the business function description may identify information relating to the type of service needed, general information regarding the size of the payroll, and other descriptive information, as well as information regarding the current supplier and current costs for obtaining the service.

Organization agent 22 may use the rule systems to interpret and describe service systems, relationships between elements in those systems, and relationships between those systems and other elements. For example, a rule system may describe internal organization of a particular supply system. As a further example, the rule system may describe contracts between manufacturers and suppliers. Using the rule system, for example, organization agent 22 can interpret, negotiate, and form potential contracts to satisfy business functions defined within the plans.

Organization agent 22 may also apply organization descriptors to identify and obtain appropriate services. For example, the organization descriptors may specify preferences, negotiation thresholds, specific business requirements, and other information uniquely detailing organization 14 and the business requirements of organization 14. The descriptors may relate generally to organization as a whole, to specific types of business functions or plans, or to individual business functions or plans.

During operation, organization 14, using organization agent 22, seeks to discover services 18 to meet various business requirements detailed within the plans. Organization agent 22 may then interact with the discovered services 18 to determine offerings, negotiate deals or portions of deals, compose multiple services 18 into aggregated functions, and otherwise fulfill other business needs. During or after appropriate interactions with services 18, organization agent 22 can finalize and request performance of services, provide feedback to appropriate individuals within organization 14, or otherwise establish relationships with or use the discovered services 18.

To discover services, system 10 contemplates organization agent 22 using any suitable techniques. In the embodiment illustrated, system 10 includes a service registry 24 to aid in finding services 18. According to particular embodiments, service providers 12 register their services 18 with one or more service registries 24. Service registry 24 then provides a centralized guide, similar to a yellow pages, to enable organizations 14 to locate services 18. Service registry 24 may include any suitable information identifying, describing, and providing information for locating services 18. For example, for each registered service 18, service registry 24 may include a high level description, such as generic descriptors from service 18, as well as a network address for contacting service 18. If the general description provided matches to basic criteria set by organization 14, organization agent 22 may then contact the identified network address, which then links to any appropriate system within service provider 12, such as service 18 or service agent 20. Organization agent 22 may then query the contacted service 18 for more detailed information and potentially access the various functions provided by service 18.

According to particular embodiments, organization agent 22 acts to monitor for potential services 18 that may provide more effective or desirable fulfillment of business requirements. To perform this monitoring, organization agent 22 may cycle through each business function specified within the plans and then seek out potential services 18 to compare against currently used services 18. As an example, consider again organization 14 having a business requirement for a materials supply service 18. Plans maintained within organization 14 may specify a number of various requirements related to the materials needs. These may range, for example, from general descriptors regarding the types of materials required down to specific descriptors detailing dates, costs, part numbers, thresholds, or other particular requirements.

Using elements such as service registry 24, organization agent 22 can discover one or more potential services 18 for fulfilling a specified business function. In the example given above, organization agent 22 may thus discover a number of services 18 providing access to materials supply systems. For example, organization agent 22 may use general descriptors related to materials supply systems to discover available supply services 18. Organization agent 22 may then determine whether the discovered services 18 match to more specific criteria set forth by plans, rules, or particular descriptors. For those matching services 18, organization agent 22 may probe for further information. For example, organization agent 22 may request quotes from each supply service 18 for particular materials. As a part of this, organization agent 22 may perform some automated negotiation to determine optimal values for a set of criteria, such as cost, delivery, processing time, and other suitable factors.

With the information received, organization agent 22 can then determine how the new supply services 18 rank as compared to any existing supply services 18. If appropriate, organization agent 22 may automatically accept quotes from new supply services 18 or may generate notifications to administrators detailing the potential new supply services 18. Organization agent 22 may continue performing this process at any appropriate times to help ensure that organization 14 continues to receive the most cost effective or desirable materials supply services. Moreover, organization agent 22 may perform similar operations with respect to other business functions.

In addition to actively seeking services 18 to fulfill business functions, organization agent 22 may also advertise various aspects of business functions and permit services 18 to initiate contacts. For example, for the supply service example, organization agent 22 may publish various general materials requirements using suitable publishing forums, such as service registry 24. Service agents 20 can browse these publications and, upon discovering matching business requirements, may contact organization agent 22 to begin interactions. Organization agent 22 and service 18 may then perform similar interactions as discussed above to determine the appropriateness of service 18 for the needs of organization 14.

In certain circumstances, a particular service provider 12 may act as an single point of contact for a bundle of services. For example, a single service provider 12 may act as a travel agency service by bundling together a number of discrete travel services. Thus organization agent 22 may access “intermediary” service agents 20 that in turn compose services 18 on behalf of organization agent 22. In such circumstances, as an example, organization agent 22 may delegate authority for scheduling all travel arrangements to an intermediary service agent 20. This permits organization agent 22 to leverage the sophisticated service bundling that can be offered by service agents 20. For example, a particular intermediary service agent 20 may have highly sophisticated processing and analysis engines to provide efficient, cost-effective, or otherwise appropriate travel arrangements.

Thus the illustration provided and the preceding description present generic elements for implementing a system to enable automated, agent-based interaction between an organization and any number of services providers. However, while the embodiment illustrated includes specific components arranged and operating in particular ways, it should be understood that this illustration, the accompanying description, and all examples given are provided only to aid in clarifying the basic concepts of these techniques, and none of these are intended to limit the scope of these concepts.

FIG. 2 is a block diagram illustrating exemplary functional elements for an agent 40 that includes an interface 42, a description 44, a knowledge base 46, plans 48, and a plan processing engine 50. Because the operation of many agents, such as service agents 20 and organization agents 22, may be similar, agent 40 and its elements and operations will be described below both generically and specifically with respect to particular types of agents. In general, agent 40 uses plan processing engine 50 to process information from plans 48 using data contained within description 44 and knowledge base 46 in order to fulfill, investigate, and/or schedule tasks specified within plans 48.

Plans 48 include, in general, the goals to be achieved by agent 40. If acting on behalf of organization 14, plans 48 may include one or more business function descriptions. These business function descriptions include both function identifications as well as one or more requirements. The business function descriptions may range from bare requests for particular services 18 to detailed plans specifying all aspects of a required service 18. Regardless, these business function descriptions enable agent 40 to discover, interact with, and judge the responses received from services 18. In particular instances, these business function descriptions may enable agent 40 to complete negotiations and automatically enter into binding requests for services. However, the level of specificity within business function descriptions may drive the extent to which agent 40 can discover and interact with appropriate services 18.

Because each type of service 18 may use different terms and standards for communication, each business function description may express requirements using different constructs or languages. However, the particular language and identifiers used within business function descriptions may be chosen from any number of possibilities, and system 10 contemplates agent 40 using business function descriptions conforming to any appropriate scheme for specifying functions and requirements.

When operating on behalf of service provider 12, agent 40 may include different types of information within plans 48. For example, agent 40 may maintain plans 48 for identifying, interacting with, and providing services 18 to organizations 14. As previously discussed, intermediary agents may also compose services 18. Thus plans 48 may provide templates or other suitable constructs for identifying and aggregating a group of other services 18 into a single offering. Also, as previously noted, service providers 12 may actively seek out organizations 14 with matching business needs. Thus plans 48 may specify activities for agent 40 to discover, contact, and interact with organization agents 22 having matching business needs.

Description 44 contains any number of descriptors specifying information associated with the entity served by agent 40. These descriptors can range from general to specific and/or dynamic. Consider agent 40 acting on behalf of organization 14. Given this relationship, description 44 will include a number of organization descriptors. These may include general descriptors, such as tax identifiers, names, addresses, and other general data. These general descriptors may also include organizational preferences for use during service discovery and management. For example, these descriptors may indicate preferences such as geographic zones for business partners and any other suitable preferences. Description 44 may further include specific and/or dynamic descriptors focused on particular business functions or types of business functions. For example, for a particular materials supply request, description 44 may include a number of request specific descriptors indicating preferences, constraints, and other suitable types of information for interacting with and judging supply services 18.

When operating on behalf of service provider 12, agent 40 maintains information describing services 18 within description 44. This information, as previously noted, may include details ranging from generic down to extremely specific information. Description 44 may include service descriptors identifying a type of service, the service provider, general information regarding the service's operation, how to locate and interface with the service, and other appropriate information. Description 44 may further include service descriptors detailing specific capabilities of service 18, such as precise features supported by service 18 and how to interface with those features. For example, for a materials supply service provider 12, description 44 may include general descriptors providing information such as name, location, pricing, interface languages supported, and other appropriate general information. Description 44 may further include specific descriptors identifying features, such as a quote feature and an order feature, and specify specific syntax for interfacing with these features.

Typically, some or all of description 44 may be exposed to other entities during various operations. When acting on behalf of service provider 12, agent 40 may publish some portion of description 44 into service registry 24. This enables other agents to find and directly contact agent 40 for further information. When acting on behalf of organization 14, agent 40 may similarly expose some or all of description 44. This enables service agents 20 to locate and propose services to organization 14. Also, during interactions, agent 40 may choose to disclose some or all of description 44.

Knowledge base 46 includes information for use by agent 40 to make decisions, negotiate with other agents, and perform other operational tasks. Whether operating on behalf of organization 14 or service providers 12, agent 40 may maintain information such as deal thresholds and other constraints that may be used during negotiations. Moreover, knowledge base 46 may include an encoding of business logic. For example, for a materials supply company, knowledge base 46 may include details for pricing products depending on a number of various factors. As an opposing example, for agent 40 acting on behalf of organization 14, knowledge base 46 may include negotiation thresholds and other suitable constraints. According to particular embodiments, knowledge base 46 may represent one or more legacy or other enterprise systems maintaining business knowledge for an organization. Thus, agent 40 can access and make decisions based upon actual information within an enterprise, while providing a wrapper of services around this central knowledge bank. Typically, agent 40 maintains most or all of knowledge base 46 hidden from other entities during operation.

As shown from the preceding discussion, description 44, knowledge base 46, and plans 48 provide various types of information with varying degrees of specificity. This permits flexibility within agent 40 when seeking out, interacting with, and identifying potential business partners. For example, a relatively simple instantiation of a business function description may permit agent 40 simply to find a number of potential services 18 for fulfilling business needs. As another example, a very detailed instantiation of a business function description accompanied by specific descriptors and an effective knowledge base may permit agent 40 to automatically find appropriate services 18, negotiate with these services, and form a contract with the most promising one of the services 18.

Interface 42 provides a link between agent 40 and other entities within system 10. Depending upon the particular types of communications and configurations within system 10, interface 42 may include any suitable combination of hardware and/or logic for interacting with other components.

Plan processing engine 50, as previously discussed, attempts to satisfy goals set forth within plans 48. When operating on behalf of organization 14, plan processing engine 50 may identify business functions, seek out services 18 to fulfill these functions, match identified services 18 against various specified requirements, and negotiate deals or preliminary aspects of deals. In the end, plan processing engine 50 may form contracts or generate notices regarding potential services 18 for fulfilling business functions.

When operating on behalf of service providers 12, plan processing engine 50 may use any suitable techniques for implementing plans 48. When contacted by organizations 14, plan processing engine 50 may execute plans 48 using knowledge base 46 and description 44 to appropriately interact with the contacting organization agent 22. Also, according to particular embodiments, selected service providers 12 may seek out organizations 14 having matching business needs. Thus plan processing engine 50 may implement plans 48 detailing steps for discovering and then interacting with organizations 14. Moreover, according to particular embodiments, selected service providers 12 may aggregate services 18 from multiple service providers 12. In these circumstances, plan processing engine 50 may execute plans 48 for performing any suitable steps to discover and aggregate multiple other services 18 into a single service offering.

While the embodiments illustrated and described focus on particular examples of agents 40 that include specific elements providing particular functions, system 10 contemplates agents 40 having any suitable combination and arrangement of elements to support template-based composition of remote services. Thus, the functionalities performed by the particular elements illustrated may be separated or combined as appropriate, and functionalities of some or all of these elements may be implemented by logic encoded in media. Moreover, some or all of the functionalities of agent 40 may be combined or distributed among other elements of system 10.

FIG. 3 is a block diagram illustrating exemplary functional elements for service 18 that includes service features 52, a description 54, and feature interfaces 56. Service features 52 operate to provide various functions supported by service 18. Feature interfaces 56 enable other entities, such as agent 40, to interface with functions provided by service features 52. Description 54 provides a number of descriptors with information about service 18. For example, description 54 may include information such as that described above with respect to description 44. Thus, description 54 may include information describing service 18, identifying functions provided by service features 52, and detailing mechanisms for accessing and interfacing with feature interfaces 56. Moreover, description 54 may include information shared between service 18 and its associated agent.

During operation, agents and other entities within system 10 may access service 18 to query for information and request service 18 to perform activities. For example, organization agent 22 may contact service 18 and query information within description 54. In response, service 18 may provide this information to organization agent 22. This information, as previously discussed, may include descriptors indicating the nature of service 18, capabilities of service 18, general message structures for interfacing with service 18, and other suitable information. The information provided to organization agent 22 from description 54 may also include details of service features 52 and techniques for accessing and interfacing with feature interfaces 56.

For example, consider service 18 providing access to a materials supply service. In response to a query from organization agent 22, service 18 may supply descriptors detailing the particular capabilities enabled by service features 52 and specify particular structures and techniques for interfacing with these service features 52 via service interfaces 56. Thus, for example, a materials supply service 18 may provide features for interactions such as obtaining product descriptions, requesting availability, requesting quotations, performing negotiations, placing purchase orders, and other appropriate features.

Using the information detailing the features, organization agent 22 may access service features 52 using feature interfaces 56. For example, organization agent 22 may access a product description interface 56 to request information regarding products. If this sufficiently matches to business requirements, organization agent 22 may request availability, quotations, perform negotiations, and otherwise access appropriate feature interfaces 56 to determine the suitability of service 18 to fulfill business requirements.

As another example, consider service 18 providing a payroll management service. In response to a query from organization agent 22, service 18 may supply descriptors detailing features such as pricing, ordering, data input, and other appropriate features. Thus, for example, organization agent 22 may access service 18 to determine the appropriate feature interfaces 56 and then interact with service 18 to determine pricing. If the pricing meets established criteria, organization agent 22 may order the payroll services and then provide information for service 18 to perform payroll functions. For example, organization agent 22 may supply employee data, payment data for each employee, banking information, and other appropriate information.

Therefore, as provided by this illustration, services 18 may include both functional aspects, such as service features 52 and feature interfaces 56, and data aspects, such as description 54. However, while illustrated as including specific elements arranged in a particular configuration, system 10 contemplates services 18 including any suitable combination and arrangement and elements for providing network accessible services. Thus, system 10 contemplates services 18 including any suitable combination of hardware and/or logic and the functionalities of services 18 being incorporated in and/or provided by any suitable network accessible equipment.

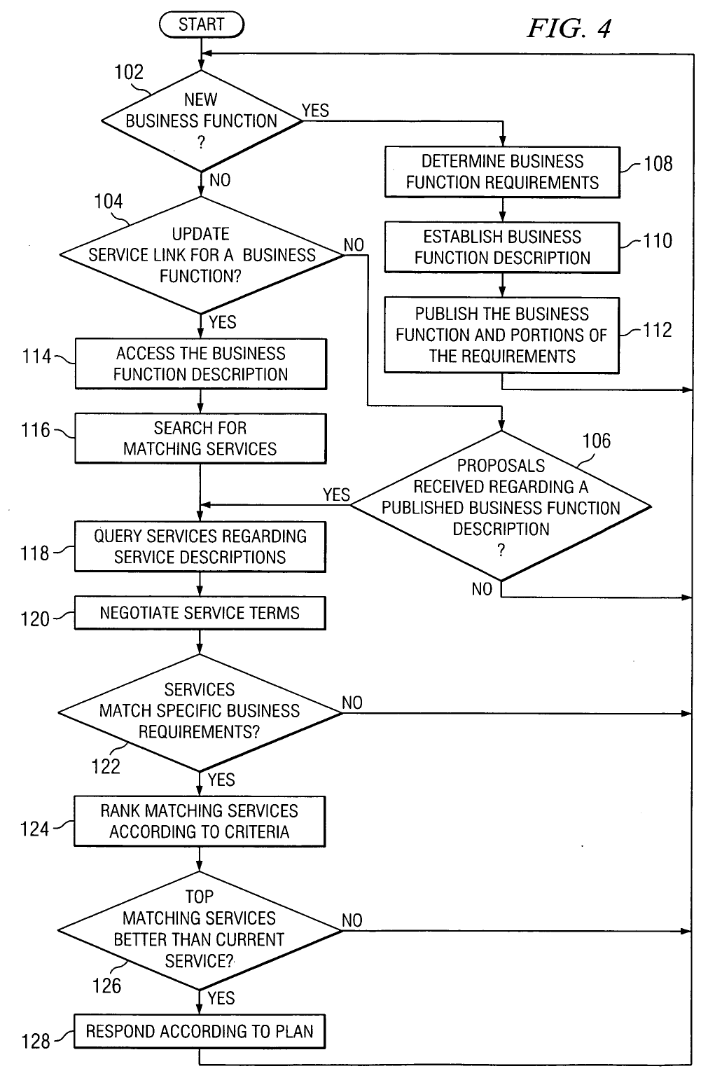

FIG. 4 is a flowchart illustrating a method for organization agent 22 to provide automated organization management of services for organization 14. The flowchart and following description detail the operation of organization agent 22 providing for the addition of new business functions and for management of existing business functions. Organization agent 22 monitors for various conditions, such as new business functions or an indication to manage an existing business function, at steps 102-106. At step 102, organization agent 22 monitors for new business functions for organization 14. For example, organization agent 22 may monitor for receipt of information defining new business functions for management by organization agent 22. As an example, an administrator may define a human resources business function and specify particular business requirements associated with the human resources function. At step 104, organization agent 22 monitors for conditions indicating a need for updating of a service link for a particular business function. For example, at appropriate times, organization agent 22 may cycle through each current business function and attempt to update the current service 18 associated with each of those business functions. At step 106, organization agent 22 monitors for and responds to proposals received regarding published business function descriptions. For example, organization agent 22 may publish information regarding various business functions required by organization 14. Service providers 12 may access these business function publications and, if appropriate, service agents 20 may automatically contact and initiate a proposal for fulfilling the published business function.

Upon identifying a new business function at step 102, organization agent 22 determines business function requirements at step 108. For example, organization agent 22 may access enterprise systems to determine various details regarding current operation. As another example, an administrator or operator may provide data regarding requirements for the specified business function. Consider, for example, organization agent 22 establishing a business function for requesting a particular type of product. Organization agent 22 may attempt to determine information regarding previous and outstanding requests for this product. Similarly, organization agent 22 may attempt to discover specific requirements for the specified business function. For example, organization agent 22 may receive pricing criteria, dates, shipping instructions, and other suitable information for fulfilling the specified business function.

Using this information, organization agent 22 establishes a business function description at step 110. For example, organization agent 22 may build a plan for fulfilling the particular business function according to the specified requirements. This description may include, for example, a business function identifier and a number of business function requirements. The identifier may enable organization agent 22 to later match which services 18 can potentially fulfill the particular type of service. The requirements permit organization agent 22 to further refine the extent to which services 18 may fulfill the business needs.

If appropriate, organization agent 22 may publish some or all of the business function description at step 112. For example, if organization 14 wishes to receive unsolicited proposals, organization agent 22 may publish information regarding the business function for access by service agents 20. As previously discussed, organization agent 22 may publish only a portion of the business function description in order to maintain portions of the business function description in confidence. For example, organization agent 22 may publish a need for a particular product and general delivery information, while maintaining pricing criteria in confidence.

As previously noted, organization agent 22 may update service links for business functions at appropriate times. For example, for each current business function, organization 14 may maintain a link to a remote service 18 designated for performing that particular business function. At appropriate times, organization agent 22 may seek out alternate service providers 12 to fulfill these business functions. To update a business function, organization agent 22 accesses the business function description at step 114. Organization agent 22 searches for matching services 18 at step 116. For example, using relatively generic descriptors maintained within the business function description, organization agent 22 may seek out services 18 registered in service registry 24 with matching service descriptors.

Organization agent 22 queries the identified services regarding specific service descriptions at step 118. This permits organization agent 22 to further refine the list of potential services 18 for fulfilling the business function requirements. For example, in this step, organization agent 22 may query for the availability and general pricing terms regarding a particular product. For those generally matching services 18, organization agent 22 may negotiate service terms at step 120. For example, using an automated, iterative process, organization agent 22 may attempt to settle upon a relatively ideal set of purchasing criteria for purchasing particular materials. Organization agent 22 determines whether any of the remaining services 18 match to the specific business requirements set forth in the business function description at step 122. For example, the business function description may include specific criteria that must be satisfied in order for particular services 18 to be considered. If services 18 remain, organization agent 22 ranks the matching services 18 according to appropriate criteria at step 124. For example, in the purchasing context, organization agent 22 may arrange various product bids based upon cost, delivery time, and other suitable criteria.

Organization agent 22 determines whether the top matching services 18 are better than the current service 18 at step 126. If so, organization agent 22 may respond according to a plan for the business function description at step 128. For example, in certain circumstances, organization agent 22 may be permitted to completely and automatically negotiate parameters associated with particular services 18. In these instances, organization agent 22 may automatically link to and authorize the identified service 18. In other instances, organization agent 22 may simply identify and/or negotiate for a potential service offering. In these instances, organization agent 22 may generate notifications or other suitable messages to alert administrators to the potential new services 18.

Therefore, the preceding flowchart and accompanying description illustrate a relatively simple method for organization agent 22 to provide automated management of services for an organization. However, the preceding flowchart and accompanying description illustrate only an exemplary method of operation, and system 10 contemplates agents and/or other suitable components using any appropriate techniques to provide these functionalities. Thus, many of the steps in this flowchart may take place simultaneously and/or in different orders than as shown. In addition, agents may use methods with additional steps, fewer steps, and/or different steps, so long as the methods remain appropriate.

Although the present invention has been described in several embodiments, a myriad of changes and modifications may be suggested to one skilled in the art, and it is intended that the present invention encompass such changes and modifications as fall within the scope of the present appended claims.

1. A method for automated management of business services comprising:
establishing an organizational database maintaining at least one business function description comprising a business function indicator and a plurality of business function requirements;
accessing a service registry using the business function indicator to identify a network address for each of a plurality of service providers each having a service indicator matching the business function indicator;
for each of the identified service providers:
communicating with the service provider to determine feature interfaces for interacting with the service provider;
accessing at least one of the feature interfaces of the service provider to determine a plurality of service descriptors describing a service provided by the service provider; and
determining whether the service provider is satisfactory based on if the service descriptors satisfy at least a portion of the business function requirements; and
ranking each of the satisfactory service providers based on the service descriptors from each of the satisfactory service providers.

2. The method of claim 1, further comprising, for each of the identified service providers, if the service provider is satisfactory, negotiating variable service descriptors using a second one of the feature interfaces for the service provider, wherein ranking each of the satisfactory service providers further comprises ranking each of the satisfactory service providers based on the service descriptors and the variable service descriptors.

3. The method of claim 2, further comprising accessing a third feature interface of the highest ranking one of the satisfactory service providers to authorize performance of the service.

4. The method of claim 2, wherein negotiating the variable service descriptors comprises:
determining a plurality of deal parameters identified within the business function requirements;
accessing a knowledge base to identify at least one negotiation threshold; and
iteratively accessing the second feature interface to negotiate the variable service descriptors, and for each iteration, modifying at least one of the deal parameters, communicating the deal parameters to the second feature interface, receiving a current version of the variable service descriptors, and comparing at least one of the variable service descriptors against the negotiation threshold.

5. The method of claim 1, further comprising generating a notification identifying at least the highest ranking one of the satisfactory service providers.

6. The method of claim 1, further comprising:
identifying a current service provider associated with the business function description;
comparing the highest ranking one of the satisfactory service providers against the current service provider; and
if the highest ranking one of the satisfactory service providers ranks higher than the current service provider, generating a notification identifying the highest ranking one of the satisfactory service providers.

7. The method of claim 1, further comprising providing organizational information to a selected one of the satisfactory service providers to enable performance of the service.

8. The method of claim 7, wherein the service comprises payroll management, and wherein the organizational information details employee data, payment data, and banking information.

9. A system for automated management of business services comprising:
a plurality of service providers each having a network address, a plurality of features providing access to a service, and a plurality of service descriptors describing the service;
a service registry maintaining, for each of the service providers, the network address and one or more published ones of the service descriptors; and
an organization agent coupled to the service providers and the service registry using a communication network, the organization agent operable to:
establish an organizational database maintaining at least one business function description comprising a business function indicator and a plurality of business function requirements;
access the service registry using the business function indicator to identify the network address for each of a plurality of the service providers, each of the identified service providers having one of the published service descriptors matching the business function indicator;
for each of the identified service providers:
communicate with the service provider to determine the features for interacting with the service provider;
access at least one of the features of the service provider to determine the service descriptors describing the service provided by the service provider; and
determine whether the service provider is satisfactory based on if the service descriptors satisfy at least a portion of the business function requirements; and
rank each of the satisfactory service providers based on the service descriptors from each of the satisfactory service providers.

10. The system of claim 9, wherein the organization agent is further operable, for each of the identified service providers, if the service provider is satisfactory, to negotiate variable service descriptors using a second one of the features of the service provider, and wherein the organization agent is further operable to rank each of the satisfactory service providers further by ranking each of the satisfactory service providers based on the service descriptors and the variable service descriptors.

11. The system of claim 10, wherein the organization agent is further operable to access a third one of the features of the highest ranking one of the satisfactory service providers to authorize performance of the service.

12. The system of claim 10, wherein the organization agent is further operable to negotiate the variable service descriptors by:
determining a plurality of deal parameters identified within the business function requirements;
accessing a knowledge base to identify at least one negotiation threshold; and
iteratively accessing the second feature to negotiate the variable service descriptors, and for each iteration, modifying at least one of the deal parameters, communicating the deal parameters to the second feature, receiving a current version of the variable service descriptors, and comparing at least one of the variable service descriptors against the negotiation threshold.

13. The system of claim 9, wherein the organization agent is further operable to generate a notification identifying at least the highest ranking one of the satisfactory service providers.

14. The system of claim 9, wherein the organization agent is further operable to:
identify a current service provider associated with the business function description;
compare the highest ranking one of the satisfactory service providers against the current service provider; and
if the highest ranking one of the satisfactory service providers ranks higher than the current service provider, generate a notification identifying the highest ranking one of the satisfactory service providers.

15. The system of claim 9, wherein the organization agent is further operable to provide organizational information to a selected one of the satisfactory service providers to enable performance of the service.

16. The system of claim 15, wherein the service comprises payroll management, and wherein the organizational information details employee data, payment data, and banking information.

17. Logic for automated management of business services, the logic encoded in a computer readable medium and operable when executed to perform the steps of:
establishing an organizational database maintaining at least one business function description comprising a business function indicator and a plurality of business function requirements;
accessing a service registry using the business function indicator to identify a network address for each of a plurality of service providers each having a service indicator matching the business function indicator;
for each of the identified service providers:
communicating with the service provider to determine feature interfaces for interacting with the service provider;
accessing at least one of the feature interfaces of the service provider to determine a plurality of service descriptors describing a service provided by the service provider; and
determining whether the service provider is satisfactory based on if the service descriptors satisfy at least a portion of the business function requirements; and
ranking each of the satisfactory service providers based on the service descriptors from each of the satisfactory service providers.

18. The logic of claim 17, further operable, for each of the identified service providers, if the service provider is satisfactory, to negotiate variable service descriptors using a second one of the feature interfaces for the service provider, wherein ranking each of the satisfactory service providers further comprises ranking each of the satisfactory service providers based on the service descriptors and the variable service descriptors.

19. The logic of claim 18, further operable when executed to perform the step of accessing a third feature interface of the highest ranking one of the satisfactory service providers to authorize performance of the service.

20. The logic of claim 18, further operable to negotiate the variable service descriptors by:
determining a plurality of deal parameters identified within the business function requirements;
accessing a knowledge base to identify at least one negotiation threshold; and
iteratively accessing the second feature interface to negotiate the variable service descriptors, and for each iteration, modifying at least one of the deal parameters, communicating the deal parameters to the second feature interface, receiving a current version of the variable service descriptors, and comparing at least one of the variable service descriptors against the negotiation threshold.

21. The logic of claim 17, further operable when executed to perform the step of generating a notification identifying at least the highest ranking one of the satisfactory service providers.

22. The logic of claim 17, further operable when executed to perform the steps of:
identifying a current service provider associated with the business function description;
comparing the highest ranking one of the satisfactory service providers against the current service provider; and
if the highest ranking one of the satisfactory service providers ranks higher than the current service provider, generating a notification identifying the highest ranking one of the satisfactory service providers.

23. The logic of claim 17, further operable when executed to perform the step of providing organizational information to a selected one of the satisfactory service providers to enable performance of the service.

24. The logic of claim 23, wherein the service comprises payroll management, and wherein the organizational information details employee data, payment data, and banking information.

25. A system for automated management of business services comprising:
means for establishing an organizational database maintaining at least one business function description comprising a business function indicator and a plurality of business function requirements;
means for accessing a service registry using the business function indicator to identify a network address for each of a plurality of service providers each having a service indicator matching the business function indicator;
means for, for each of the identified service providers:
communicating with the service provider to determine feature interfaces for interacting with the service provider;
accessing at least one of the feature interfaces of the service provider to determine a plurality of service descriptors describing a service provided by the service provider; and
determining whether the service provider is satisfactory based on if the service descriptors satisfy at least a portion of the business function requirements; and
means for ranking each of the satisfactory service providers based on the service descriptors from each of the satisfactory service providers.
